(19) United States
(12) Patent Application Publication
(10) Pub. No.: US 2019/0224837 A1
(43) Pub. Date: Jul. 25, 2019

(54) Handle for a Tool

(71) Applicant: Ira Herbert Hoell, III, Wilmington, NC (US)

(72) Inventor: Ira Herbert Hoell, III, Wilmington, NC (US)

(21) Appl. No.: 16/255,078

(22) Filed: Jan. 23, 2019

Related U.S. Application Data
(60) Provisional application No. 62/621,301, filed on Jan. 24, 2018.

(51) Int. Cl. B25G 1/10; A01D 7/00; A46B 5/00

(52) U.S. Cl. CPC B25G 1/102; A01B 1/026; A46B 5/002; A01D 7/00

(57) ABSTRACT

A handle for a tool that provides multiple gripping locations for a user to grasp and manipulate the tool. The handle includes a main shaft, a first extension that extends outward from a first location along the main shaft, and a second extension that extends outward from a second location along the main shaft. The handle provides multiple gripping locations along one or more of the main shaft, the first extension, and the second extension.

### RELATED APPLICATIONS

This application claims priority to U.S. Provisional Application No. 62/621,301, filed Jan. 24, 2018, the disclosure of which is incorporated herein by reference in its entirety.

### BACKGROUND

Tools are used to perform a variety of functions. Examples of tools include but are not limited to rakes, shovels, hoes, and brooms. The tools include a handle with an elongated shaft. A tool implement such as a rake head or shovel head is mounted at one end of the shaft. During use, the user grasps the shaft with both hands and applies a force to manipulate the tool implement as necessary.

The configuration of handle may make it difficult for the user to grasp and use the tool. The shaft usually includes a straight shape. The straight shape can require the user to place their bodies in physically awkward positions to manipulate the tool implement as necessary to perform the specific task. For example, the user may have to position their arms in lowered or elevated positions to perform various tasks. The user may also have to bend or crouch down to perform the specific task.

The configuration of the handle can also position the user in a physical position that could injure the user. The user may injure their back due to having to bend or stoop over when using the tool. Further, the user may injure their arms or wrists due to the awkward positional requirements for holding the handle. The configuration of the handle may make it difficult for the user to provide the necessary amount of leverage on the tool.

### SUMMARY

The present application is directed to a handle for a tool. The handle provides for a user to grasp the tool at different locations.

One aspect is directed to a handle for a tool. The handle includes a main shaft with a first end configured to receive a tool implement and an opposing second end. The main shaft has a length measured between the first end and the second end. A first extension extends outward from the main shaft between the first and second ends. A second extension extends outward from the main shaft at the second end and is spaced away from the first extension along the length. Each of the first extension and the second extension extend outward on a same side of the main shaft. Each of the first and second extensions includes a first end at the main shaft, and an opposing terminal end positioned away from the main shaft.

In another aspect, the first and second extensions overlap with the main shaft, and the first and second extensions are spaced apart along the length of the main shaft in a non-overlapping arrangement.

In another aspect, the first and second extensions have identical shapes.

In another aspect, the first and second extensions are in a same plane.

In another aspect, the main shaft is straight.

In another aspect, a terminal end section of each of the first extension and the second section is straight and parallel with the main shaft.

One aspect is directed to a handle for a tool. The handle includes a main shaft with a first end configured to receive a tool implement and an opposing second end. A first extension extends outward in a first direction from the main shaft between the first and second ends. A second extension extends outward in the first direction from the main shaft at the second end and is spaced away from the first extension along the main shaft. Each of the first extension and the second extension include a first section that extends outward from the main shaft and a second section that extends from the first section and is parallel with the main shaft.

In another aspect, each of the main shaft and the second sections are straight.

In another aspect, each of the first extension and the second extension include a terminal end at the second section.

In another aspect, each of the first sections extends outward from the main shaft at an acute angle.

In another aspect, the first and second extensions overlap with the main shaft, and the first and second extensions are spaced apart along the main shaft to not overlap with each other along the main shaft.

In another aspect, the first extension and the second extension have identical shapes.

In another aspect, the first extension and the second extension extend outward in a same direction from the main shaft.

In another aspect, the first extension and the second extension are in the same plane.

In another aspect, the main shaft is straight.

One aspect is directed to a handle for a tool. The handle includes a main shaft having a first end configured to receive a tool implement and an opposing second end with the main shaft having a length measured between the first end and the second end. First and second extensions extend outward from the main shaft between the first and second ends with each of the first and second extensions comprising a first section that extends outward from the main shaft at an acute angle and a second section that is spaced away from the main shaft and includes a straight shape that is parallel with the main shaft, with the first section being positioned between the main shaft and the second section. The main shaft, the first extension, and the second extension are positioned in a plane. The first extension and the second extension are positioned on a same side of the main shaft.

In another aspect, the first extension overlaps the main shaft along a first section of the main shaft, the second extension overlaps the main shaft along a second section of the main shaft, and the first section and the second section are spaced apart along the main shaft in a non-overlapping position.

In another aspect, the first sections extend outward from the main shaft at different acute angles.

In another aspect, the second section of the first extension is positioned a different distance away from the main shaft than the second section of the second extension.

In another aspect, a gap is positioned along the main section between a terminal end of the second section of the first extension and the second extension.

One embodiment is directed to a handle that includes a main shaft having a first end configured to receive a tool implement and an opposing second end. A first extension extends outward from the main shaft between the first and second ends. A second extension extends outward from the main shaft at the second end and is spaced away from the first extension. Each of the first and second extensions includes a first end at the main shaft, and an opposing terminal end positioned away from the main shaft.

The handle can also include the first and second extensions overlapping with the main shaft and with the extensions spaced apart along the main shaft to not overlap with each other along the main shaft.

The handle can also include the first and second extensions having identical shapes.

The handle can also include the first and second extensions extending outward from the main shaft in the same direction.

The handle can also include the first and second extensions being in the same plane.

The handle can also include the main shaft being straight.

Another embodiment is directed to a handle for a tool that includes a main shaft having a first end configured to receive a tool implement and an opposing second end. A first extension extends outward from the main shaft between the first and second ends. A second extension extends outward from the main shaft at the second end and is spaced away from the first extension. Each of the extensions includes a first section at the first end that extends outward from the main shaft and a second section that extends from the first section and is parallel with the main shaft.

The handle can also include each of the main shaft and the second sections being straight.

The handle can also include each of the extensions including a terminal end at the second section.

The handle can also include the first sections extending outward from the main shaft at an acute angle.

The handle can also include each of the first and second extensions with a first end at the main shaft, an opposing terminal end positioned away from the main shaft, and the first and second extensions overlapping with the main shaft and with the extensions spaced apart along the main shaft to not overlap with each other along the main shaft.

The handle can also include the first and second extensions having identical shapes.

The handle can also include the first and second extensions extending outward from the main shaft in the same direction.

The handle can also include the first and second extensions being in the same plane.

The handle can also include the main shaft being straight.

### BRIEF DESCRIPTION OF THE DRAWINGS

FIG. 1 is a perspective view of a handle for a tool with a tool implement attached to the handle.

FIG. 2 is a side schematic view of a handle for a tool.

FIG. 3 is a partial side schematic view of a second extension that extends outward from a main shaft of a handle.

FIG. 4 is a partial side schematic view of an extension that extends outward from a main shaft of a handle.

FIG. 5 is a partial side schematic view of an extension that extends outward from a main shaft of a handle.

FIG. 6 is a partial side schematic view of a handle for a tool.

FIG. 7 is a perspective end view of a handle with a tool implement mounted at an end of the handle.

FIG. 8 is a perspective view of a handle with a mounted tool implement.

FIG. 9 is a side view of braces attached to a main shaft and first extension of a handle.

FIG. 10 is a side view of a handle.

FIG. 11 is a side view of a handle.

### DETAILED DESCRIPTION

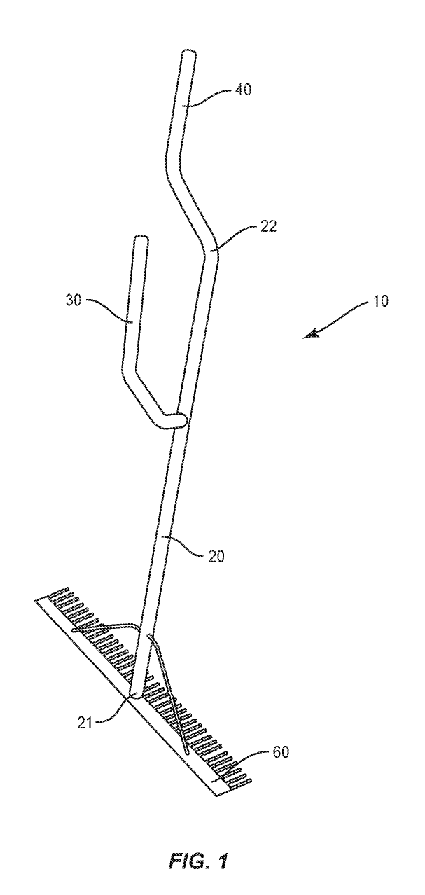

The present application is directed to a handle for a tool. The handle provides multiple gripping locations for a user to grasp and manipulate the tool. FIG. 1 illustrates a handle 10 for a tool. The handle 10 includes a main shaft 20, a first extension 30 that extends outward from a first location along the main shaft 20, and a second extension 40 that extends outward from a second location along the main shaft 20. The handle 10 provides multiple gripping locations along one or more of the main shaft 20, the first extension 30, and the second extension 40.

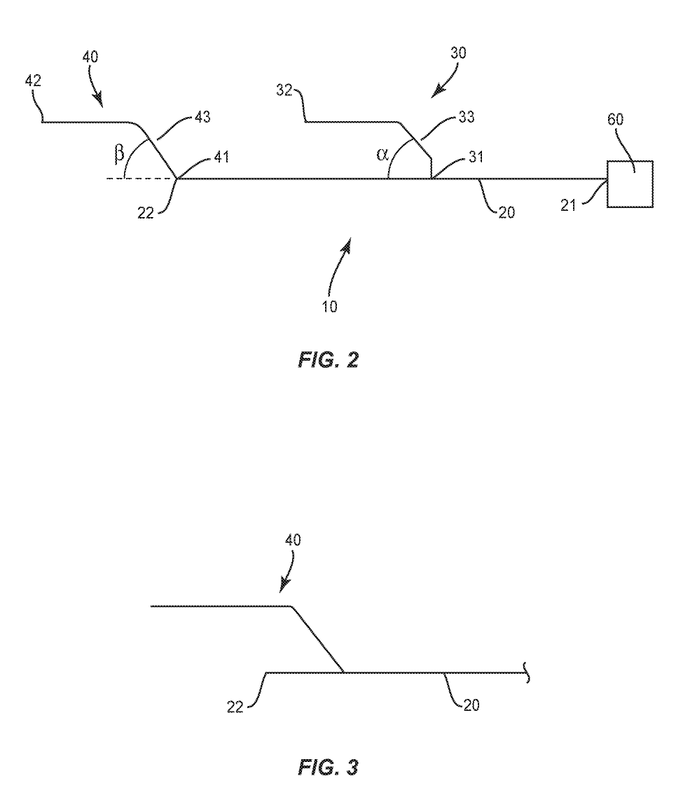

The main shaft 20 includes an elongated shape with a length that extends between a first end 21 and an opposing second end 22. FIG. 2 includes the main shaft 20 being straight. The main shaft 20 can also include other shapes including but not limited to a bend along one or more sections of the length, one or more straight sections connected together at angles, and a continuous curve that extends between the first and second ends 21, 22. The main shaft 20 can include various lengths. A specific design includes a length of about 50 inches.

The first end 21 is configured to receive a tool implement 60. Tool implements 60 can include but are not limited to a hard rake head as illustrated in FIG. 1, a shovel head, a hoe head, a broom head, a grading rake head, and a leaf rake head.

The first extension 30 extends outward from the main shaft 20 at a point between the first and second ends 21, 22. The first extension 30 includes a first end 31 at the main shaft 20, and a terminal second end 32 that is spaced away from the main shaft 20.

The second extension 40 is positioned along the main shaft 20 and extends from the main shaft 20 at a point farther away from the first end 21 than the first extension 30. The second extension 40 includes a first end 41 at the main shaft 20, and a terminal second end 42 that is spaced away from the main shaft 20. The second extension 40 can extend outward from the main shaft 20 at different locations along the length. FIGS. 1 and 2 include the second extension 40 positioned at the second end 22. The second extension 40 can also extend outward from the main shaft 20 inward from the second end 22 as illustrated in FIG. 3. In this design, the second terminal end 22 of the main shaft 20 can provide another grasping location for the user.

The lengths of the first and second extensions 30, 40 measured between the respective first and second ends 31, 32, 41, 42 can vary. One design includes a length of about 17 inches. The first and second extensions 30, 40 can include the same or different lengths and/or shapes.

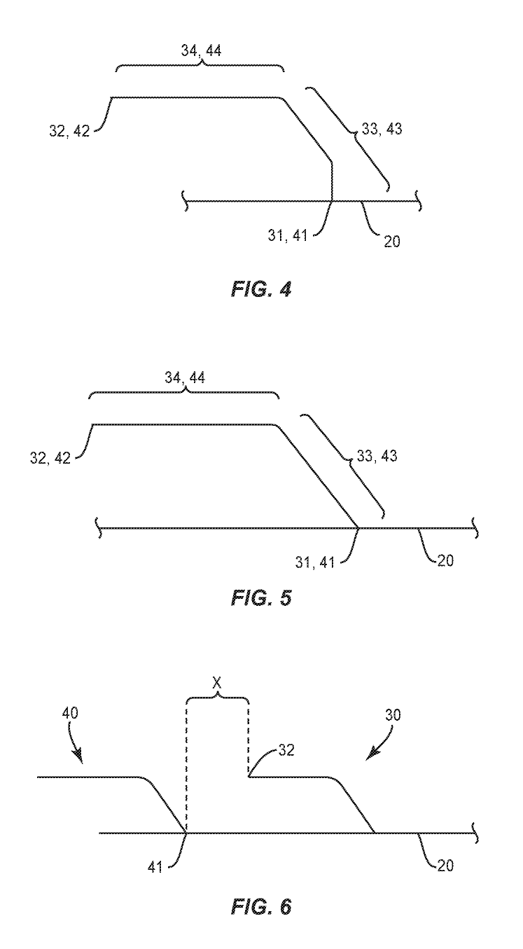

The first and second extensions 30, 40 can each include respectively a first section 33, 43 and a second section 34, 44. FIG. 4 illustrates a design with the first sections 33, 43 constructed from multiple lengths that each includes a straight shape. FIG. 5 includes the first sections 33, 43 constructed from a single member.

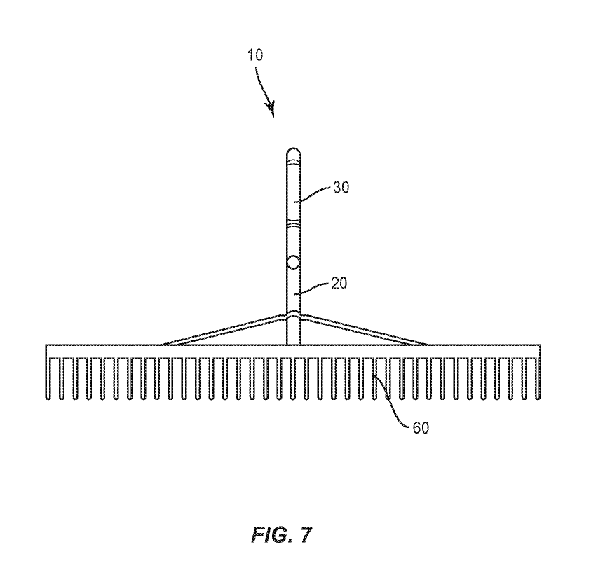

The first and second extensions 30, 40 extend outward from the main shaft 20 in the same direction. This can include the first and second extensions 30, 40 extending outward from the main shaft 20 in the same plane. FIG. 7 illustrates an end view of a tool 10 with the main shaft 20 and the first extension 30 and second extension 40 being in the same plane (second extension 40 is positioned behind the first extension 30 and not visible in FIG. 7).

The second sections 34, 44 of one or both of the first and second extensions 30, 40 can be straight. One or both of the second sections 34, 44 can be parallel with the main shaft 20 which can also be straight. The second sections 34, 44 can be positioned the same distance away from the main shaft 20, or can be positioned different distances away from the main shaft 20.

The first and second extensions 30, 40 each extend outward from the main shaft 20 and away from the first end 21. As illustrated in FIG. 2, the first section 33 extends away from the first end 21 and is positioned at an acute angle α relative to the main shaft 20. The first section 43 of the second extension 40 is positioned at an acute angle β relative to the main shaft 20. These angles α, β can vary, with one design including each of the angles being about 45°. These angles α, β of the various handle designs can be the same or can be different.

As illustrated in FIG. 6, the first extension 30 overlaps with the main section 20. The first extension 30 is spaced away from the second extension 40 so there is no overlap between the extensions 30, 40. That is, a distance x measured along the main shaft 20 extends between the second end 32 of the first section 30 and the first end 41 of the second section 40. This spacing facilitates grasping and manipulating the first extension 30 by the user. The distance x can vary in length.

The handle 10 can be constructed from a variety of different materials. Materials include but are not limited to fiberglass, wood, metal, plastic, rubber, ceramic, and carbon fiber. The entirety of the handle 10 can be constructed from the same material, or one or more different sections can be constructed from different materials. The handle 10 can be constructed as a single, unitary piece. Alternatively, the handle 10 can be constructed from two or more different pieces that are connected together. Connection methods can include but are not limited to mechanical fasteners such as screws, rivets, pins, welds, threaded connections, and mechanical joints. One or more of the main section 20, first extension 30, and second extension 40 can be solid, or can be hollow.

Grips can be positioned along the handle 10. The grips can be constructed from a flexible material to facilitate grasping and holding the handle 10. In one design, grips are positioned at the terminal ends of one or both of the first and second extensions 30, 40.

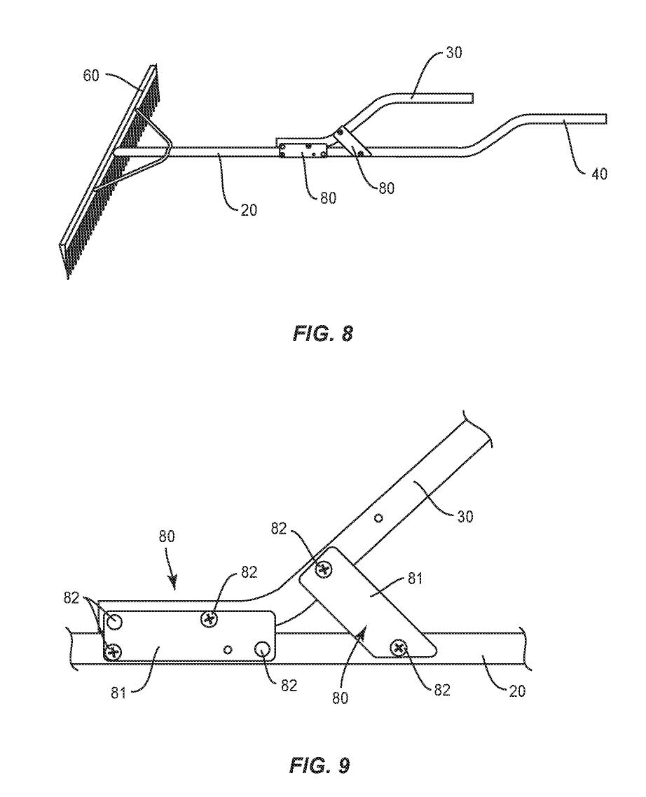

One or more braces 80 can be positioned to support one or both of the first and second extensions 30, 40. FIGS. 8 and 9 illustrate braces 80 attached to the main shaft 20 and the first extension 30. The braces 80 include pairs of opposing plates 81 that are secured together by one or more fasteners 82. A first plate 81 is positioned on a first side of the main shaft 20 and the first extension 30, and a second plate 81 is positioned on an opposing second side. The fasteners 82 extend between and secure the plates 81. The size and positioning of the plates 81 can vary to provide the necessary support and structure.

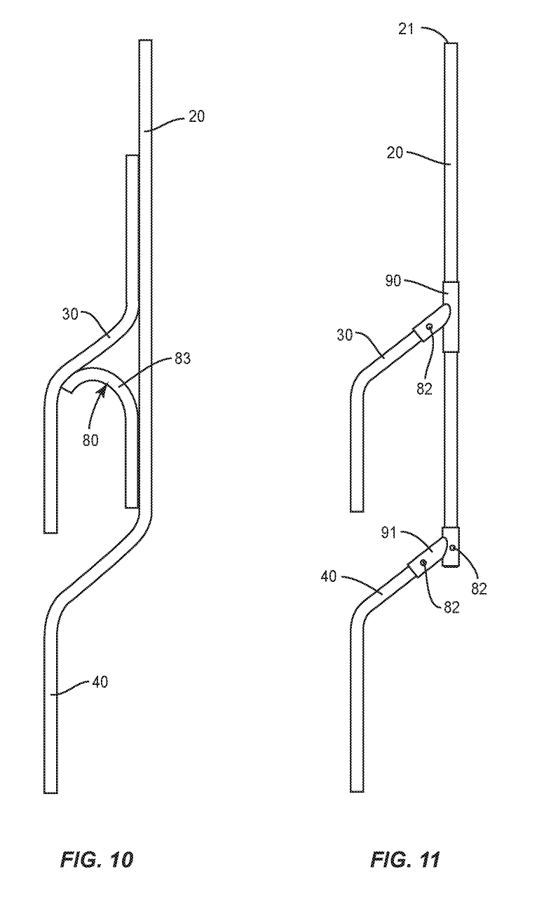

FIG. 10 illustrates a brace 80 with a curved shape and positioned between the main shaft 20 and the first extension 30. In one design, the brace 80 is positioned in the same plane as the main shaft 20 and the first extension 30. As illustrated in FIG. 10, the brace 80 contacts against and supports the inner sides of the main shaft 20 and first extension 30.

FIG. 11 includes a handle 10 that includes first and second housings 90, 91 to connect together two or more different elements. The first housing 90 includes a first receptacle that receives a leading section of the main shaft 20 (i.e., the section that extends from the first end 21. The first housing 90 also includes a second receptacle to receive the first extension 30 and a third receptacle to receive a second section of the main shaft 20. The second housing 91 includes a first receptacle to receive the second section of the main shaft 20 and a second receptacle to receive the second extension 40. In one design, each receptacle includes a circular sectional shape and the main shaft 20 and extensions 30, 40 are sized to be inserted into the receptacles. Fasteners 82 can secure the elements in the housings 90, 91. The housings 90, 91 can also be secured to the various components by welds and friction fit.

The handle 10 can be constructed from various numbers of separate elements. One design includes the main shaft 20 and the second extension 40 constructed from a first element, and the first extension 30 constructed from a separate element.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

1. A handle for a tool, the handle comprising:
a main shaft with a first end configured to receive a tool implement and an opposing second end, the main shaft having a length measured between the first end and the second end;
a first extension that extends outward from the main shaft between the first and second ends;
a second extension that extends outward from the main shaft at the second end and is spaced away from the first extension along the length;
each of the first extension and the second extension extend outward on a same side of the main shaft; and
each of the first and second extensions includes a first end at the main shaft, and an opposing terminal end positioned away from the main shaft.

2. The handle of claim 1, wherein the first and second extensions overlap with the main shaft, and with the first and second extensions spaced apart along the length of the main shaft in a non-overlapping arrangement.

3. The handle of claim 1, wherein the first and second extensions have identical shapes.

4. The handle of claim 1, wherein the first and second extensions are in a same plane.

5. The handle of claim 1, wherein the main shaft is straight.

6. The handle of claim 5, wherein a terminal end section of each of the first extension and the second section is straight and parallel with the main shaft.

7. A handle for a tool, the handle comprising:
a main shaft with a first end configured to receive a tool implement and an opposing second end;
a first extension that extends outward in a first direction from the main shaft between the first and second ends;
a second extension that extends outward in the first direction from the main shaft at the second end and is spaced away from the first extension along the main shaft; and
each of the first extension and the second extension comprises a first section that extends outward from the main shaft and a second section that extends from the first section and is parallel with the main shaft.

8. The handle of claim 7, wherein each of the main shaft and the second sections are straight.

9. The handle of claim 7, wherein each of the first extension and the second extension include a terminal end at the second section.

10. The handle of claim 7, wherein each of the first sections extend outward from the main shaft at an acute angle.

11. The handle of claim 7, wherein the first and second extensions overlap with the main shaft, and the first and second extensions are spaced apart along the main shaft to not overlap with each other along the main shaft.

12. The handle of claim 7, wherein the first extension and the second extension have identical shapes.

13. The handle of claim 7, wherein the first extension and the second extension extend outward in a same direction from the main shaft.

14. The handle of claim 7, wherein the first extension and the second extension are in the same plane.

15. The handle of claim 7, wherein the main shaft is straight.

16. A handle for a tool, the handle comprising:
a main shaft having a first end configured to receive a tool implement and an opposing second end, the main shaft having a length measured between the first end and the second end;
first and second extensions that extend outward from the main shaft between the first and second ends, each of the first and second extensions comprising a first section that extends outward from the main shaft at an acute angle and a second section that is spaced away from the main shaft and includes a straight shape that is parallel with the main shaft, with the first section being positioned between the main shaft and the second section;
the main shaft, the first extension, and the second extension being positioned in a plane; and
the first extension and the second extension being positioned on a same side of the main shaft.

17. The handle of claim 16, wherein the first extension overlaps the main shaft along a first section of the main shaft, the second extension overlaps the main shaft along a second section of the main shaft, and the that first section and the second section are spaced apart along the main shaft in a non-overlapping position.

18. The handle of claim 16, wherein the first sections extend outward from the main shaft at different acute angles.

19. The handle of claim 16, wherein the second section of the first extension is positioned a different distance away from the main shaft than the second section of the second extension.

20. The handle of claim 16, further comprising a gap positioned along the main section between a terminal end of the second section of the first extension and the second extension.
